(19) United States
(12) Patent Application Publication
(10) Pub. No.: US 2007/0189162 A1
(43) Pub. Date: Aug. 16, 2007

(54) Method for setting multicast and broadcast service in broadband wireless access system

(75) Inventors: Kwan-Woong Song, Seoul (KR); Yong-Deok Kim, Seoul (KR); Young-Hun Joo, Yongin-si (KR); Han-Sang Kim, Yeongtong-gu (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/636,832

(22) Filed: Dec. 11, 2006

(30) Foreign Application Priority Data
Feb. 15, 2006 (KR) 2006-14858

(51) Int. Cl. H04L 12/26

(52) U.S. Cl. 370/230

(57) ABSTRACT

A method for setting a multicast and broadcast service (MBS) of a broadband wireless access system includes: previously receiving and storing the information on the MBS setting from a MBS server by a radio access station; and broadcasting the information on the MBS setting stored in the PSS, which exists in the service area of the radio access station, by the radio access station. In the step of broadcasting the information on the MBS setting, a preset pilot tone, uplink/downlink information, or the sub-carriers unused in bandwidth of the system are used for broadcasting the information.

### CLAIM OF PRIORITY

This application claims priority to an application entitled “Method For Setting Multicast and Broadcast Service In Broadband Wireless Access System,” filed with the Korean Intellectual Property Office on Feb. 15, 2006 and assigned Serial No. 2006-14858, the contents of which are incorporated herein by reference.

### BACKGROUND OF THE INVENTION

1. Field of the Invention

The present invention relates to a broadband wireless access system such as Wireless Broadband (WiBro), and more particularly to signal regulations between a Multicast and Broadcast service (MBS) server and a portable subscriber station (PSS) and its related communication protocol.

2. Description of the Related Art

A broadband wireless access system such as WiBro transmit wireless data using an Orthogonal Frequency Division Multiple Access/Time Division Duplex (OFDMA/TDD) scheme based on Internet Protocol (IP), which provides uplink and downlink asymmetric transmission to support low and high speed various data service, including a multimedia application service for providing high definition moving pictures, a voice service. Such a broadband wireless access system is based on wireless media using a broadband, such as 2 GHz, 5 GHz, 26 GHz, and 60 GHz, etc., which may access Public Switched Telephone Network (PSTN), Public Switched Data Network (PSDN), Internet, and International Mobile Telecommunication-2000 (IMT-2000) Network, etc., and may support a channel transmission rate of more than 2 Mbps.

The 802.16 standardization group of the Institute of Electrical and Electronics Engineers (IEEE) has standardized a wireless access scheme for the broadband wireless access system and has propelled the establishment of the IEEE 802.16d and IEEE 802.16e standards as standards for providing the broadband wireless access service for fixed or portable subscriber stations (PSS) to date.

In the broadband wireless access system based on the IEEE 802.16e standard, when a PSS transmits data in a unicast scheme, the PSS uses a Traffic Encryption Key (TEK) received through Privacy Key Management (PKM) in order to encrypt data. The TEK is applied to a specific connection to encipher traffic during the valid time of the TEK using an encryption algorithm defined by IEEE 802.16 Privacy Sublayer and Initialization Vector (IV), which is used for encryption.

Meanwhile, as described above, IEEE 802.16d/e standard defines the unicast scheme in which communication with a PSS is carried out to transmit packet data. That is, the data sending and receiving are performed by appointing a specific user's address, and a service is supplied to the corresponding user in an access network by allocating the band for data transmission. However, the unicast scheme will cause waste of resources and undesirable load of system in a network and wireless communication sections if the same data is transmitted to multiple users at the same time. Therefore, a multicast scheme has been developed for simultaneously saving resources and providing existing data service. The multicast is also applied to the IEEE 802.16d/e standard in order to efficiently use the resources and various service media in the mobile communication system for high-speed data transmission.

Thus, the broadband wireless access system according to the IEEE 802.16d/e may provide the multicast and broadcast service (MBS), and an MBS server providing the MBS takes precedence over Access Control Router (ACR). The MBS server plays roles of transmitting the MBS information to the PSS, authenticating the service, acquiring the encryption key, and accounting tasks.

FIG. 1 shows the flow of signals and access methods when the PSS accesses the MBS server. More particularly, FIG. 1 is a flowchart illustrating the operation of setting for MBS in a WiBro system. Referring to FIG. 1, first, when a portable subscriber station (PSS) goes to an awake mode (step 101), the PSS and radio access station generally search for the MBS server by using a dynamic host configuration protocol (DHCP, step 102). Then, the PSS requests the contents list to the searched MBS server (step 103) and receives the contents list from the MBS server (step 104).

A contents list includes a title of MBS contents related to the broadcast to watch, multicast IP addresses, port numbers, MBS identifier (ID), MBS Connection ID (CID), and MBS zone identifier.

Then, the PSS enters in an idle mode and can go to the awake mode again (steps 105 and 106). The PSS requests a broadcast service watch to the radio access station (step 107) by transmitting the dynamic service addition (DSA)-request (REQ) message set in advance to the radio access station. The DSA-REQ message includes an IP address, a port number and the like, of the multicast which a user wants to watch.

The radio access station transmits the receipt notification message of the DSA-REQ, in other words, a DSx-xxx-Received (DSX-RVD) message to the PSS (step 108), and then processes the authentication with MBS server (step 109). Continuously, the radio access station transmits the MBS zone identifier and the downlink information such as lower layer information, which is necessary for a corresponding physical layer and medium access control (MAC) layer (step 110), using the ‘DSA-RSP’ message.

The PSS, which has received the lower layer information suitable for the broadcast, transmits the PKM key request message (PKM-REQ) to the radio access station (step 111). As a result, the radio access station performs the authorization and accounting with the MBS server (step 112) and transmits the PKM key response message (PKM-RSP) to the PSS (step 113). The PSS receives the MBS packet from MBS server through the radio access station and decodes the broadcasting traffic encoded by the radio access station to view the MBS packet.

As illustrated in FIG. 1, the PSS may access the MBS server for MBS. However, as described above, at initial access, the PSS carries out a step of acquiring the MBS contents list from the MBS server through uplink signals to the MBS and identifying the MBS contents list. At this moment, it takes many routes to transmit from the initial signal which the PSS generates to the contents list for MBS, and these signals are treated as generic communication data, and thus results in the waste of bandwidth between the radio access station and the PSS.

### SUMMARY OF THE INVENTION

Accordingly, the present invention has been developed to solve the above-mentioned problem occurring in the art and provides additional advantages, by providing a method for setting an MBS of a broadband wireless access system, which can improve the speed of setting an MBS and prevent the waste of a bandwidth between a PSS and a radio access station.

In one embodiment, there is provided a method for setting an MBS of a broadband wireless access system, which includes the steps of: previously receiving and storing MBS setting information from an MBS server by a radio access station; and broadcasting the MBS setting information stored in the PSS which exists in the service area of the radio access station.

Preferably, in the step of broadcasting the MBS setting information, a preset pilot tone, uplink/downlink information, or an unused sub-carrier in a bandwidth of the system is used for the broadcasting.

### BRIEF DESCRIPTION OF THE DRAWINGS

The above features and advantages of the present invention will be more apparent from the following detailed description taken in conjunction with the accompanying drawings, in which:

FIG. 1 is a flowchart illustrating processes of setting a multicast and broadcast service (MBS) in a conventional WiBro system;

FIG. 2 is a view illustrating a configuration of a WiBro system according to the present invention;

FIG. 3 is a flowchart illustrating processes of setting an MBS in a WiBro system according to an embodiment of the present invention;

FIG. 4 is a view illustrating the configuration of a map used for setting the MBS in a WiBro system according to the embodiment of the present invention; and

FIG. 5 is a view illustrating a method of allocating a sub-carrier in order to set a MBS in a WiBro system according to the embodiment of the present invention.

### DETAILED DESCRIPTION

Hereinafter, an exemplary embodiment of the present invention will be described in detail with reference to the accompanying drawings. The detailed description of the concrete structural elements in the following disclosure is provided only for helping understanding the present invention overall. It will be obvious to those skilled in the art that any modifications or changes may be made to the structural elements in the scope of the present invention.

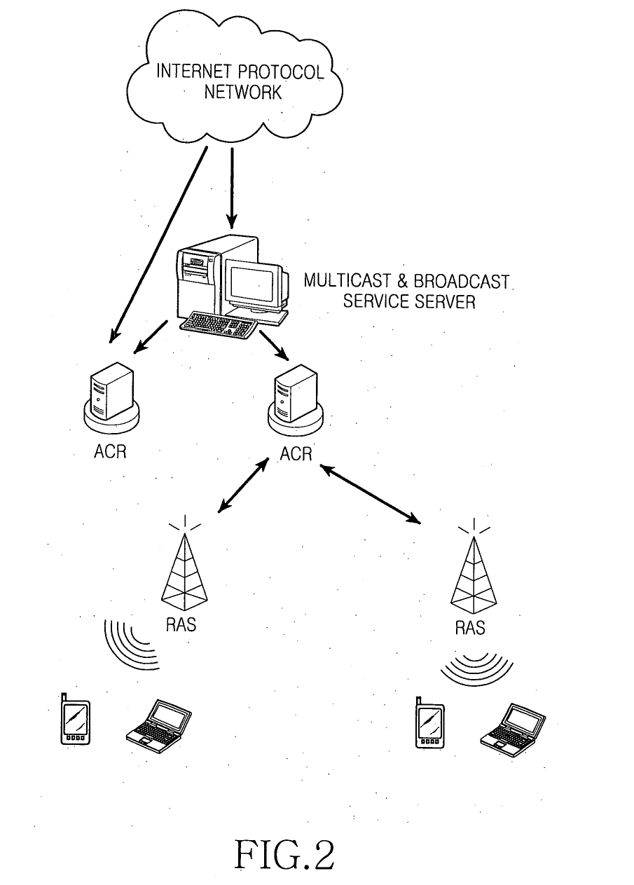

FIG. 2 is a view illustrating a configuration of a WiBro system according to the present invention. As illustrated in FIG. 2, the WiBro system includes a plurality of radio access stations (RASs) and an access control router (ACR) connected to a network so as to control the RASs.

Here, the RASs have assigned service areas, i.e. cells, respectively, and provide services to a plurality of portable subscriber stations (PSSs, for example, lap-top computer, PDA and the like). An MBS server, which takes the precedence over ACR and provides multicast and broadcast service (MBS), provides MBS contents list to the PSS requiring MBS and plays roles in authenticating the PSS needing the service, providing session controls, and accounting. The MBS server and a specific ACR may be interlinked with the IP network.

In addition, WiBro systems may have a home agent (not shown here) for supporting the IP mobility of PSS in a home network, and an Authentication, Authorization, and Accounting (AAA) server for authenticating users and PSS, authorizing the users and PSS to access the network, and asking for an account of the user in order to provide the network access and service only for registered users.

In WiBro system shown in FIG. 2, the signal is transmitted through the RAS and the ACR in communication between the PSS and the server. At this time, it is necessary to allocate the bandwidth between the RAS and the PSS. According to the feature of the present invention, in order to improve the method in which the PSS requiring the MBS to access the existing MBS server independently receives resources from the RAS and communicates with the MBS server, the RAS not only processes the flow of signals between the PSS and MBS server but also allows the PSS to receive the flows of signal to the MBS contents list by using broadcasting channels from the RAS to the PSS.

At this moment, there are three methods of setting the broadcasting channel for transmitting the MBS contents list between the RAS and the PSS. One of them is to transmit information on the MBS by setting the same pilot using the feature of the synchronous WiBro system, another is to use the carriers which are arranged around the outside of 768 data sub-carriers, and the third is to separate and transmit the MBS contents list using the sufficient space of a compressed MAP or normal MAP. Hereinafter, the operations of the present invention will be described in detail with reference to the accompanying drawings.

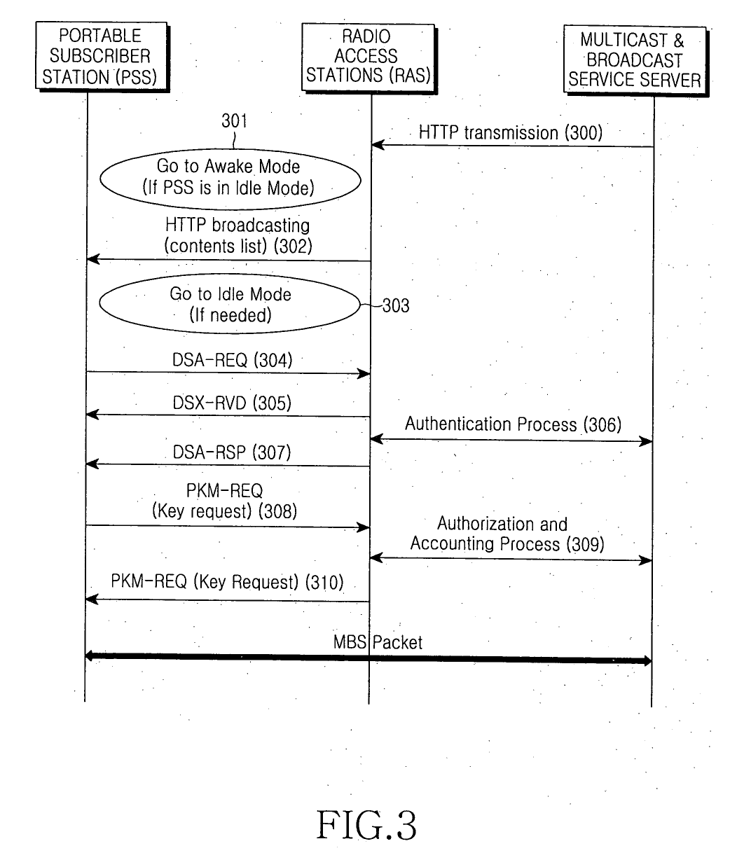

FIG. 3 is a flowchart illustrating an operational process of setting an MBS in a WiBro system according to an embodiment of the present invention. Referring to FIG. 3, the RAS receives and stores, in advance, information on the MBS setting information, such as an MBS contents list (step 300). The RAS broadcasts the corresponding MBS setting information to the PSS (step 302) when the PSS located in the service area of the RAS is in an awake mode (step 101).

The MBS content list may includes titles of MBS contents related to the broadcasting to be watched, a multicast IP address, a port number, an MBS identifier (ID), an MBS Connection ID (CID), and an MBS zone identifier and the like.

Next, the PSS may go to idle mode and then to awake mode again (step 303). The PSS requests the broadcasting service watch (step 304) by transmitting, in advance, the generated dynamic service addition-request (DSA-REQ) messages to the RAS. The DSA-REQ message contains the multicast IP address to be watched, and the port number, etc. Note that the PSS directly uses the MBS after receiving the contents list (not going to the idle mode, but directly going to step 304), or goes to an idle mode after receiving only the contents list, in which the PSS goes to awake mode again and then proceeds to step 304 in order to use the MBS after some time.

The RAS transmits a receipt notification message corresponding to the DSA-REQ message, i.e. DSx-xxx-received (DSX-RVD) message, to the PSS (step 305), processes the authentication along with MBS server (step 306), and transmits downlink information such as lower layer information including the corresponding physical layer and medium access control (MAC), and the MBS zone identifier and the like, to the PSS.

The PSS, which receives the lower layer information necessary for the broadcasting, transmits the PKM key request message (PKM-REQ) to the RAS (step 308). Thus, the RAS processes the authentication and accounting with MBS server (step 309) and transmits the PKM key response message (PKM-RSP) to the PSS (step 310). Finally, the PSS receives the MBS packets from the MBS server through the RAS to decode the broadcasting traffics encoded by the RAS and watches them.

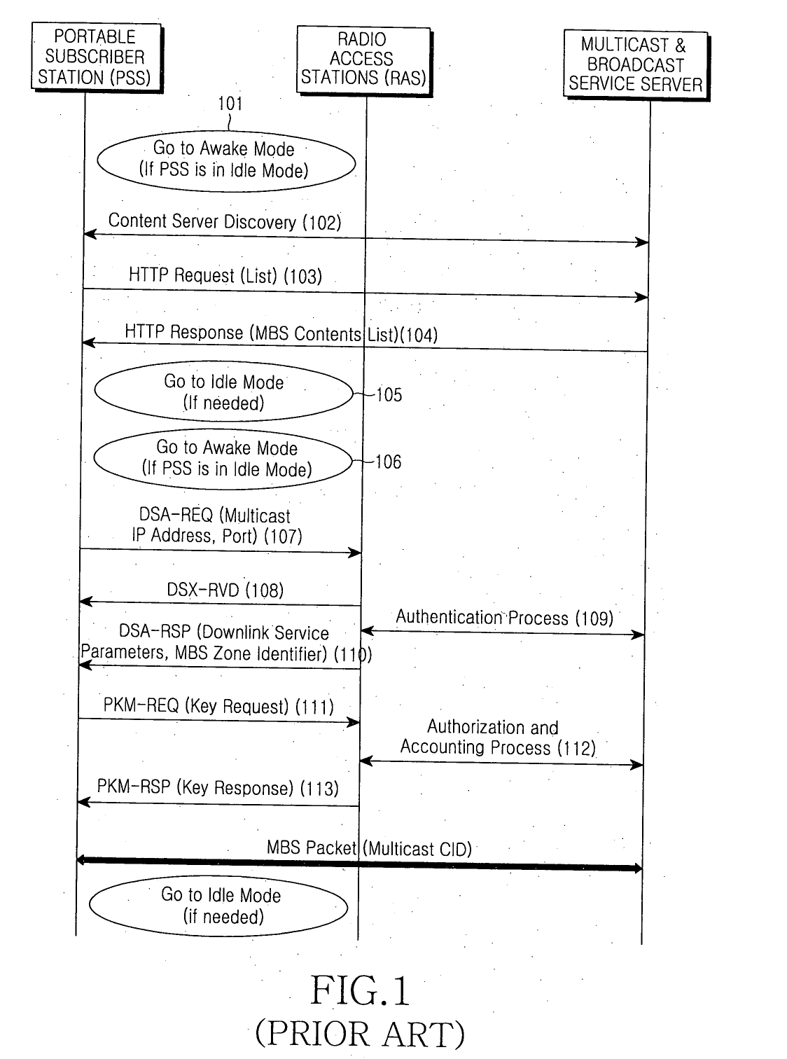

As illustrated in FIG. 3, according to the teachings of the present invention, the PSS can access the MBS server for the MBS. Comparing the processes according to the feature of the present invention as illustrated in FIG. 3 with the prior art as illustrated in FIG. 1, the processes from step 102 to step 104 in the conventional signal processes are related to the initial access, in which it is possible to manage the transmitting information in the same way. Specifically, the RAS and the PSS use MBS CID as a CID in order to maintain an MBS, which is set to use the same value in MBS zone, regardless of the RAS. Meanwhile, the conventional processes procedure from step 107 to step 113 as illustrated in FIG. 1 is to authenticate the PSS and to ask for the account of the user, and should be carried out in accordance with the PSSs, i.e. the users.

However, since the contents which are transmitted through the processes from the step 102 to the step 104 as illustrated in FIG. 1 may have the same information and may be received by all the PSSs, it is not always necessary for each PSS to receive the contents through the WiBro data transmission every time when the user needs MBS service. Accordingly, the processes from step 102 to step 104 as illustrated in FIG. 1 are not performed by an MBS server in the present invention. Rather, the RAS receives the information in advance from the MBS server, and broadcasts it to the PSS in the RAS.

The methods for broadcasting the MBS information can be classified into three types. First method is to use a specific pilot tone which is adjustably set in the general method for transmitting data between a PSS and an RAS in a WiBro network. It is universal and the most stable transmitting method, but has a defect of losing a part of the bandwidth. Second method is to separate and transmit the MBS contents list by using the residual space of a compressed MAP or normal MAP, and the third method is to use the carrier, which is arranged around the outside of 768 data sub-carriers.

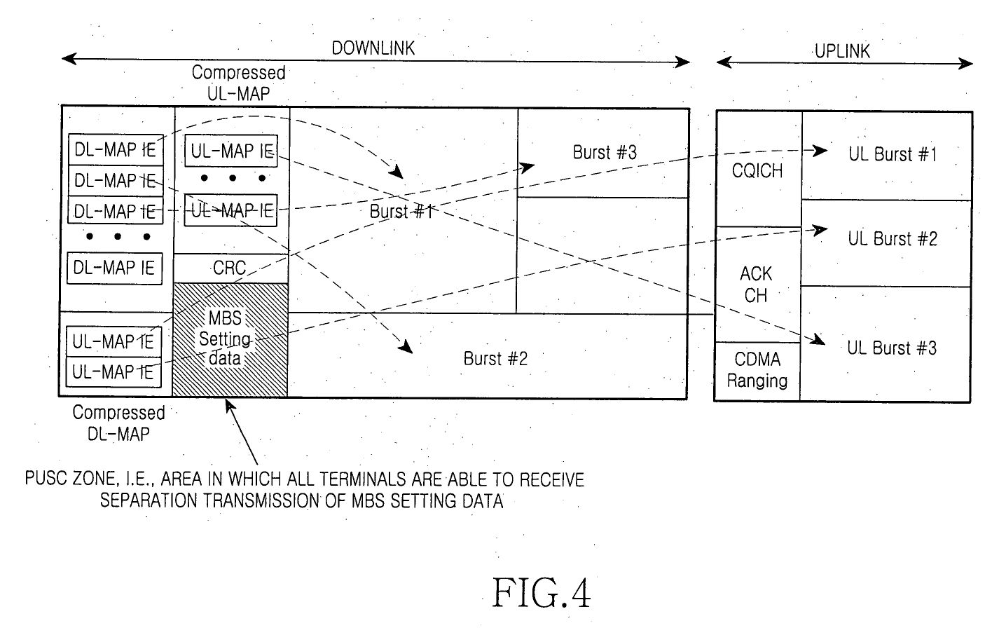

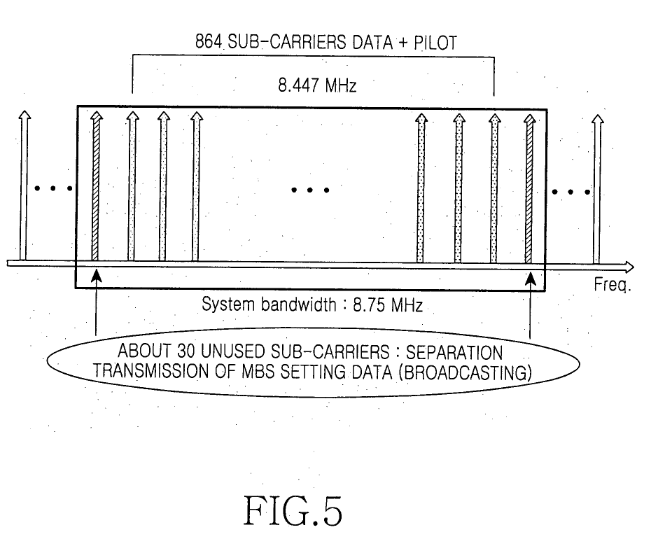

Hereinafter, the second and the third methods will be described in detail with reference to FIGS. 4 and 5, respectively.

FIG. 4 is a view illustrating the configuration of a map used for setting the MBS in a WiBro system according to the embodiment of the present invention, and more particularly shows the construction of the compressed MAP according to the IEEE 802.16d/e. In the IEEE 802.16d/e standard, characteristic information on the channel is notified to the PSS by separating the information on the channel into an uplink channel and downlink channel, and defining information on the each channel as a type, length, value (TLV) to transmit the information, which is included in the downlink channel descriptor (DCD) and uplink channel descriptor (UCD) messages, to all of users periodically. The RAS broadcasts the information on the uplink/downlink for RAS access corresponding to each frame in order for a mobile PSS to access the uplink/downlink channel. The information on the uplink/downlink is called a MAP message, which can be classified into an uplink MAP and a downlink MAP, respectively. The mobile PSS receives the MAP message from the RAS to analyze the message. It is possible for the PSS to access the uplink/downlink in the RAS by receiving the burst section through information on the UL/DL-MAP information element (IE), which represents the transmission level for the corresponding PSS included in the MAP message and the magnitude of allocated resources. The MAP may be classified into a normal map, a compressed map and the like according to their construction.

As described in FIG. 4, the construction of the compressed MAP according to IEEE 802.16d/e includes a downlink sub-frame (DOWNLINK) and an uplink sub-frame (UPLINK). Specifically, the downlink sub-frame (DOWNLINK) includes the compressed downlink MAP information (DL-MAP) field, the compressed uplink MAP information (UL-MAP) field, and the downlink burst field.

The RAS allocates the burst section to the PSS through the UL/DL-MAP IE in the MAP. The available burst sections for each PSS are expressed in the UL/DL-MAP IE information in the MAP information of FIG. 4. That is, the downlink MAP information (DL-MAP) includes the DL-MAP IE information. As marked by arrows in FIG. 4, the available burst sections in downlink sub-frame (DOWNLINK) for each PSS are expressed. Furthermore, the uplink MAP information (UL-MAP) includes the UL-MAP IE information. As marked by arrows in FIG. 4, the available burst sections in uplink sub-frame (UPLINK) for each PSS are expressed. According to the sorts of service which the PSS uses, the burst sections are allocated uniformly.

According to the present invention, for example, in the MAP of the present invention, it is possible to broadcast the information on the MBS setting by using the residual space in uplink/downlink MAP information (DL-MAP, UL-MAP) fields, as shown in FIG. 4. The method for broadcasting the information on the MBS setting using the MAP illustrated in FIG. 4 is to use the empty space of the MAP area that all the PSSs have to receive usually. Specifically, as illustrated in FIG. 4, it is possible to acquire much more transmission band using the compressed MAP or a normal MAP extension version.

FIG. 5 is a view illustrating a method of allocating sub-carrier in order to set an MBS in a WiBro system according to the embodiment of the present invention. The method shown in FIG. 5 uses about 30 sub-carriers located and unused within 8.75 MHz system bandwidth in a WiBro system that utilizes the 768 data sub-carriers among the 1,024 sub-carriers and 96 pilot sub-carriers.

As illustrated in FIG. 5, for example, in a normal WiBro system, the overall transmission frequency bands are divided into 1,024 sub-channels. Further, data and pilot are transmitted to the central 890 sub-carriers (especially, 864 sub-carriers among them), which corresponds to 8.75 MHz band, among 1,024 sub-carriers, and are not transmitted to the other 130 sub-carriers. The reason for leaving the sub-carriers in both sides empty is to reduce the noise leaked out of the band. According to the present invention, the information on the MBS setting is broadcasted by using about 30 unused sub-carriers among 890 sub-carriers corresponding to the 8.75 MHz band. In this case, only the downlink signal is transmitted from the RAS to the PSS in order to only transmit broadcasting data for the MBS without applying the existing 5 msec frame period and TDD. Thus, the system merely may have the modulator corresponding to the frequency band of the corresponding sub-carrier.

As illustrated in FIGS. 4 and 5, a broadcasting operation of the information on the MBS setting according to an embodiment of the present invention may be executed. At this time, it is no obstacle to separate and transmit the quantity of data for MBS, such as the MBS contents list actually to be transmitted, several times in all the cases. The PSS continuously receives the signal according to a specific format, and provides a user with the signal when the user wants. Hence, it is possible to receive the corresponding data regardless of the access on/off time of the PSS by designing the RAS to transmit the corresponding data periodically.

As described above, the method for setting a multicast and broadcast service in a broadband wireless access system according to the present invention is able to shorten the time on which actually a user spends on receiving the practical MBS data from the MBS server for the MBS service in a broadband wireless access system like a WiBro system, and additionally prevents the waste of bandwidth between the RAS and the PSS in network.

As described above, the process of setting a multicast and broadcast service in a broadband wireless access system according to an embodiment of the present invention may be performed. While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for setting a multicast and broadcast service (MBS) in a broadband wireless access system, the method comprising the steps of:
receiving and storing the information, in advance, on a MBS setting information from a MBS server by a radio access station (RAS) in communication with a plurality of portable subscriber stations (PSS); and
broadcasting, by the radio access station (RAS), the MBS information setting to the PSS located in the service area of the radio access station (RAS).

2. The method as claimed in claim 1, wherein a preset pilot tone is used for broadcasting the MBS setting information in the broadcasting step.

3. The method as claimed in claim 1, wherein uplink/downlink information is used in the broadcasting step.

4. The method as claimed in claim 1, wherein sub-carriers unused in the system bandwidth are used in the broadcasting step.

5. The method as claimed in claim 2, wherein all of the information on the MBS setting information is divided and transmitted in the broadcasting step.

6. The method as claimed in claim 1, wherein the MBS setting information is broadcasted when the PBS is in a wake mode.

7. The method as claimed in claim 1, wherein the MBS setting information includes one or more of titles of the MBS to be watched, a multicast IP address, a port number, an MBS identifier (ID), an MBS Connection ID (CID), and an MBS zone identifier.
